(19) United States
(12) Patent Application Publication
(10) Pub. No.: US 2010/0238411 A1
(43) Pub. Date: Sep. 23, 2010

(54) PROJECTION TYPE DISPLAY DEVICE

(75) Inventor: Takaaki TANAKA, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/721,070

(22) Filed: Mar. 10, 2010

(30) Foreign Application Priority Data
Mar. 19, 2009 (JP) 2009-067411

(51) Int. Cl. G03B 21/14

(52) U.S. Cl. 353/31

(57) ABSTRACT

A projection-type display apparatus includes a light separating element that separates white light from an illumination optical system, first and second color separating elements that separate the separated white light beams into blue, green, and red light beams, three transmission-type liquid crystal light valves each for the right eye and for the left eye that modulate the color-separated light beams according to video signals, first and second color combining elements that each combine the blue, green, and red light beams that have been modulated, first and second wavelength-selective polarization rotating elements that respectively rotate the polarization direction of predetermined color lights from the first and second color combining elements so that the polarization directions of the color lights are aligned, a polarized light combining element that combines two polarized light beams that have polarization directions orthogonal to each other from the wavelength-selective polarization rotating elements, and a projection lens that magnifies and projects images respectively formed by the two combined polarized light beams. Using one projection-type display apparatus, it is possible to display stereoscopic video with little cross talk of images for the right eye and for the left eye, and no flicker, without needing high-speed response for the light valves.

### BACKGROUND OF THE INVENTION

1. Field of the Invention

The present invention relates to a projection-type display apparatus that irradiates an image formed on a light valve with illumination light, and magnifies and projects the image on a screen using a projection lens, and in particular relates to a projection-type display apparatus for stereoscopic display.

2. Description of Related Art

JP 2005-65055A, for example, discloses that a video display apparatus for stereoscopic display is composed of one projection-type display apparatus that uses liquid crystal panels for light valves, aiming to make the apparatus small and easy to be installed, and enabling stable stereoscopic display images to be obtained. This conventional projection-type display apparatus is shown in FIG. 4.

An optical system 60 that forms images for blue, green, and red color lights is composed of a light source lamp 61, dichroic mirrors 62 and 63 for color separation, reflection mirrors 64, 65, and 66, and liquid crystal panels 67r, 67g, and 67b for image formation. Blue, green, and red light beams from the liquid crystal panels 67r, 67g, and 67b are combined by a combining prism 68, and the combined light is projected using a projection lens 70 via polarization rotation liquid crystal 69. The polarization rotation liquid crystal 69 switches the polarization direction of the projection light between 0° and 90°.

Blue, green, and red light for the right eye and for the left eye alternately are emitted from the optical system 60 for each field. At this time, the timing for emitting the green light for the right eye and for the left eye is shifted by one field relative to the timing for emitting the red and blue light for the right eye and for the left eye. Furthermore, the polarization direction of the projected light from the combining prism 68 is switched between 0° and 90° for each field by the polarization rotation liquid crystal 69. Accordingly, stereoscopic images can be viewed using polarization glasses.

In order to control polarization at a high speed, OCB mode liquid crystal whose response speed is about 5 msec, ferroelectric liquid crystal having high-speed response on the order of microseconds, or the like is used as the polarization rotation liquid crystal 69. JP 2005-65055A discloses that with the above configuration, it is possible to display stereoscopic video with little flicker, using one small projection-type display apparatus for displaying projection images, for which installation adjustment is easy.

However, since an image for the right eye and an image for the left eye are formed and switched for each field, cross talk occurs, that is, the image for the right eye enters the left eye, and the image for the left eye enters the right eye. Significant cross talk results in a double image. Further, since an image for the right eye and an image for the left eye are switched by time division, a slow switching speed causes flicker to occur. In order to eliminate crosstalk and flicker, the high-speed response is necessary not only for liquid crystal cells for polarization control, but also for liquid crystal light valves for image formation.

The response of a liquid crystal light valve necessary for high definition, high quality image display is at least 8 msec or less, and desirably a liquid crystal light valve has response of 5 msec or less. A practical liquid crystal light valve used in a projection-type display apparatus is constituted from TN mode liquid crystal or VA mode liquid crystal, whose response speed is 10 msec or more. Therefore, it has been a problem to secure a response of 5 msec or less with such a liquid crystal light valve.

To address this, an image display apparatus for stereoscopic display disclosed in WO 2006/135867 is provided with a sub-system that forms an image for the right eye, and a sub-system that forms an image for the left eye, and the image display apparatus has a configuration in which an image for the right eye and an image for the left eye whose polarization directions differ from each other are combined, and projected simultaneously. Therefore, it is not necessary to switch between an image for the right eye and an image for the left eye for each field, thus reducing the possibility of crosstalk and flicker to occur as with the above-described configuration disclosed in JP 2005-65055A.

However, this image display apparatus uses reflection-type light valves, and a configuration suitable for the case of using transmission-type light valves, particularly transmission-type liquid crystal light valves is not disclosed. Specifically, in the case of using transmission-type liquid crystal light valves, it is necessary to adopt a configuration that takes into consideration the selection of elements and the arrangement thereof, for instance, such that optimal settings are obtained for the optical operation with respect to the respective color lights of images for the right eye and images for the left eye, which are different from the settings for the case of using reflection-type light valves.

### SUMMARY OF THE INVENTION

Therefore, with the foregoing in mind, it is an object of the present invention to provide a stereoscopic display apparatus that is configured by one projection-type display apparatus that uses transmission-type liquid crystal light valves such that the stereoscopic display apparatus can display stereoscopic video with very little cross talk of images for the right eye and for the left eye, and no flicker, without needing high-speed response for the light valves.

A projection-type display apparatus of the present invention includes a light source, an illumination optical system that condenses light from the light source and illuminates an illumination area with the condensed light, a light separating element that separates white light from the illumination optical system in two directions, first and second color separating elements that each separate the white light from the light separating element into blue, green, and red light beams, three transmission-type liquid crystal light valves for the right eye that modulate the colors of light beams from the first color separating elements according to a video signal for the right eye, three transmission-type liquid crystal light valves for the left eye that modulate the colors of light beams from the second color separating elements according to a video signal for the left eye, a first color combining element that combines the blue, green, and red color lights that have been modulated by the three liquid crystal light valves for the right eye, a second color combining element that combines the blue, green, and red color lights that have been modulated by the three liquid crystal light valves for the left eye, a first wavelength-selective polarization rotating element that, from among the color lights combined by the first color combining element, rotates a polarization direction of a first predetermined color light so as to be aligned with a first polarization direction that is the same as a polarization direction of another color light, a second wavelength-selective polarization rotating element that, from among the color lights combined by the second color combining element, rotates a polarization direction of a second predetermined color light so as to be aligned with a second polarization direction that is the same as a polarization direction of another color light, the second polarization direction being orthogonal to the first polarization direction, a polarized light combining element that combines two polarized light beams that exit from the first and second wavelength-selective polarization rotating elements, and a projection lens that magnifies and projects images respectively formed by the two polarized light beams combined by the polarized light combining element.

The projection-type display apparatus having the above configuration includes light valves for image formation for the right eye and image formation for the left eye, and thus projection images for the right eye and the left eye are simultaneously formed in a continuous manner without switching image light by time division. Therefore, it is possible to perform bright and high definition stereoscopic display with little cross talk and no flicker, without needing light valves having a high response speed. Further, image light for the right eye and image light for the left eye is combined using wavelength-selective polarization rotating elements and a polarized light combining element, and thereafter magnified and projected using one projection lens, thus achieving a projection-type display apparatus that easily can be installed and can perform stable stereoscopic display.

### BRIEF DESCRIPTION OF THE DRAWINGS

FIG. 1 is a diagram showing the configuration of a projection-type display apparatus according to Embodiment 1 of the present invention.

FIG. 2 is a diagram showing polarization transmittance characteristics of a wavelength-selective polarization rotating element.

FIG. 3 is a diagram showing the configuration of a projection-type display apparatus according to Embodiment 2 of the present invention.

FIG. 4 is a diagram showing the configuration of a conventional projection-type display apparatus.

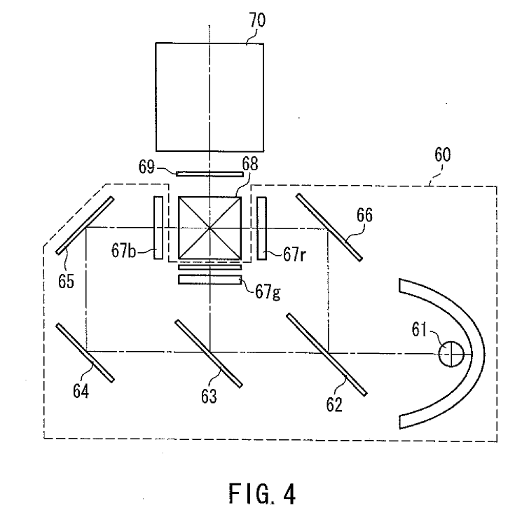

### DETAILED DESCRIPTION OF THE INVENTION

Based on the configuration described above, a projection-type display apparatus of the present invention can be modified as follows.

Specifically, a configuration can be adopted in which first and second polarizing elements that each absorb an unnecessary polarized light component are provided between the polarized light combining element and the first and second wavelength-selective polarization rotating elements. Cross talk of image light for the right eye and image light for the left eye can be reduced further by using the polarizing elements, thereby enabling stereoscopic display with high image quality.

The polarized light combining element can be constituted by the polarized light combining element is a polarizing beam splitter having a dielectric thin film formed thereon. Alternatively, the polarized light combining element can be constituted by a wire grid-type polarizing prism.

A configuration can be adopted in which one of the first and second wavelength-selective polarization rotating elements is set so as to rotate polarization of the red and blue light beams from the color combining element 90 by degrees, and the other is set so as to rotate polarization of the green light beam from the color combining element 90 by degrees.

The light separating element can be constituted by the light separating element is a half mirror having a dielectric thin film formed thereon, which separates light into transmitted light and reflected light in a ratio of 1:1.

Alternatively, the light separating element can be constituted by a flat wire grid-type polarized light separating mirror. In this case, a configuration can be adopted in which the wire grid-type polarized light separating mirror includes a retardation plate that rotates polarization of transmitted light.

A configuration can be adopted in which the liquid crystal light valve is composed of TN mode liquid crystal or VA mode liquid crystal panel.

Hereinafter, the present invention will be described by way of illustrative embodiments with reference to the drawings.

### Embodiment 1

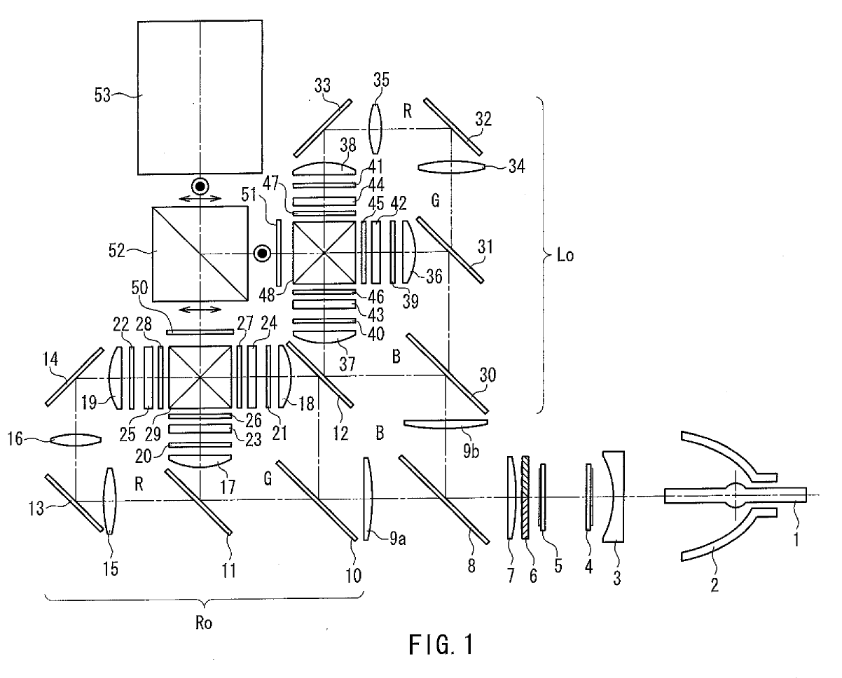

FIG. 1 is a configuration diagram showing a projection-type display apparatus according to Embodiment 1 of the present invention. A TN mode or VA mode transmission-type liquid crystal panel is used for each liquid crystal light valve.

A discharge lamp 1 is used as a light source, and arranged inside a reflecting mirror 2. A concave lens 3 is arranged on the condensing side of the reflecting mirror 2, and on the exiting side of the concave lens, an illumination optical system is arranged, which is composed of first and second lens array plates 4 and 5, a polarization converting element 6, and condensing lenses 7, 9a, and 9b. A half mirror 8 is arranged on the exiting side of the condensing lens 7, and separates the light beam from the condensing lens 7 into transmitted light and reflected light, which are caused to respectively enter the condensing lenses 9a and 9b. The condensing lens 9a is provided for a right eye optical system (Ro) for forming an image for the right eye, and the condensing lens 9b is provided for a left eye optical system (Lo) for forming an image for the left eye.

The right eye optical system (Ro) is composed of a blue reflection dichroic mirror 10, a green reflection dichroic mirror 11, reflection mirrors 12, 13, and 14, relay lenses 15 and 16, field lenses 17, 18, and 19, incident side polarizing plates 20, 21, and 22, liquid crystal panels 23, 24, and 25, exit side polarizing plates 26, 27, and 28, a color combining prism 29, and a wavelength-selective polarization rotating element 50. The color combining prism 29 is composed of a red reflection dichroic mirror and a blue reflection dichroic mirror.

The left eye optical system (Lo) is composed of a blue reflection dichroic mirror 30, a green reflection dichroic mirror 31, the reflection mirror 12, reflection mirrors 32 and 33, relay lenses 34 and 35, field lenses 36, 37, and 38, incident side polarizing plates 39, 40, and 41, liquid crystal panels 42, 43, and 44, exit side polarizing plate 45, 46, 47, a color combining prism 48, and a wavelength-selective polarization rotating element 51. The color combining prism 48 is composed of a red reflection dichroic mirror and a blue reflection dichroic mirror.

Light exiting from the wavelength-selective polarization rotating element 50 of the right eye optical system (Ro), and light from the wavelength-selective polarization rotating element 51 of the left eye optical system (Lo) are combined by a polarized light combining prism 52, and the combined light is projected by a projection lens 53.

The configuration of this projection-type display apparatus and the operation thereof are described below in detail. The light emitted from the discharge lamp 1 is condensed by the reflecting mirror 2, and converted into substantially parallel light by the concave lens 3. The light converted into substantially parallel light enters the first lens array plate 4 that is constituted by a plurality of lens elements. The light beam that has entered the first lens array plate 4 is divided into a large number of beams of light. Each lens element of the first lens array plate 4 has an aperture shape that is similar to the shape of the liquid crystal panels 23, 24, 25, 42, 43, and 44. The divided large number of light beams converge onto the second lens array plate 5 that is constituted by a plurality of lenses. The focal length of the lens elements of the second lens array plate 5 is determined such that the first lens array plate 4 and the liquid crystal panels 23, 24, 25, 42, 43, and 44 are substantially in a conjugate relation.

The light that exits from the second lens array plate 5 enters the polarization converting element 6. The polarization converting element 6 is composed of a polarized light separating prism and a half wave plate, and converts natural light from the lamp into light having one polarization direction. The light from the polarization converting element 6 enters the condensing lens 7. The condensing lenses 7, 9a, and 9b are used for illuminating, in a superimposed manner, the liquid crystal panels 23, 24, 25, 42, and 43 and 44 with light that has exited from the lens elements of the second lens array plate 5. The light from the condensing lens 7 is separated into light beams of transmitted light and reflected light in the ratio of 1:1, by the half mirror 8 (light separating element) obtained by forming a dielectric multilayer film on a glass substrate.

The transmitted light into which the light has been separated by the half mirror 8 passes through the condensing lens 9a, and thereafter enters the right eye optical system (Ro). Then, the light is separated into color lights of blue, green, and red by the blue reflection dichroic mirror 10 and the green reflection dichroic mirror 11 that constitute a first color separating element. The green light passes through the field lens 17 and the incident side polarizing plate 20, and enters the liquid crystal panel 23. The blue light is reflected by the reflection mirror 12, thereafter passes through the field lens 18 and the incident side polarizing plate 21, and enters the liquid crystal panel 24. The red light is transmitted and refracted by the relay lenses 15 and 16, reflected by the reflection mirrors 13 and 14, then passes through the field lens 19 and the incident side polarizing plate 22, and enters the liquid crystal panel 25.

The three liquid crystal panels 23, 24, and 25 for the right eye for forming right eye image are TN mode transmission-type liquid crystal panels using an active matrix system, and change the polarization state of the entering light in accordance with the control of the voltage applied to pixels according to a video signal. The incident side polarizing plates 20, 21, and 22 and the exit side polarizing plates 26, 27, and 28 are arranged on both sides of the liquid crystal panels 23, 24, and 25 respectively, such that the transmission axes are orthogonal to each other. The combinations of the liquid crystal panels 23, 24, and 25, the incident side polarizing plates 20, 21, and 22, and the exit side polarizing plates 26, 27, and 28 constitute the liquid crystal light valves for the right eye with respect to the respective color lights. The color lights are modulated by the respective liquid crystal light valves for the right eye, thus forming green, blue, and red images for the right eye.

The respective color lights that have passed through the exit side polarizing plates 26, 27, and 28 enter the color combining prism 29 serving as a first color combining element. In the color combining prism 29, red light and blue light are reflected respectively by the red reflection dichroic mirror and the blue reflection dichroic mirror, and combined with green light. The liquid crystal light valves for the right eye with respect to the respective color lights are constituted such that the reflecting surfaces of the color combining prism 29 transmit and reflect green light as p-polarized light, and red and blue light as s-polarized light. The reason for using green light in the p-polarized light state, and blue and red light in the s-polarized light state is because transmittance or reflectance can be increased in a wide band due to the spectral characteristics with respect to the respective color lights.

The combined light that has passed through the color combining prism 29 enters the first wavelength-selective polarization rotating element 50. The first wavelength-selective polarization rotating element 50 is constituted by laminating retardation films, and has a function of rotating the polarization direction of the light in a specified wavelength band. The first wavelength-selective polarization rotating element 50 rotates the polarization direction of blue and red light by 90 degrees, and does not rotate the polarization direction of green light. Accordingly, all the green, blue, and red color lights become p-polarized light, and enter the polarized light combining prism 52.

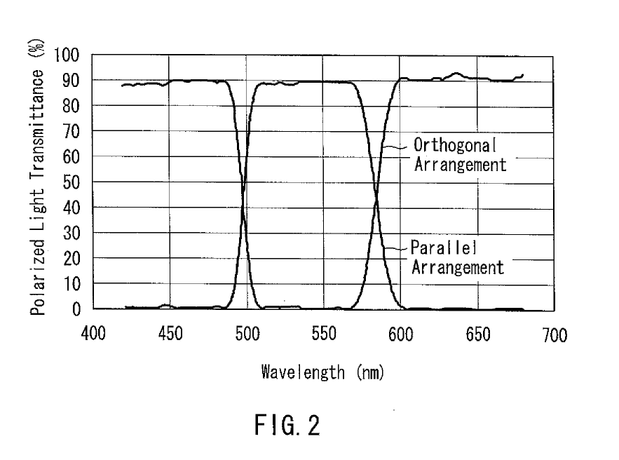

FIG. 2 shows the polarization transmittance of the wavelength-selective polarization rotating element 50. This shows the result obtained by measuring the transmittance for each wavelength in the state where a polarizer and an analyzer are arranged such that their absorption axes are orthogonal or parallel to each other, and the wavelength-selective polarization rotating element is arranged between the polarizer and the analyzer. In the case where the polarizer and the analyzer are arranged such that their absorption axes are orthogonal to each other, the polarization directions of the light in the blue and red bands are rotated, and thus the transmittances in the blue and red light bands are high. On the other hand, in the case where the polarizer and the analyzer are arranged such that their absorption axes are parallel to each other, the transmittance of the light in the green band, whose polarization direction is not rotated, is high.

On the other hand, the light reflected by the half mirror 8 passes through the condensing lens 9b, and thereafter enters the left eye optical system (Lo). Then, the light is separated into blue, green, and red light by the blue reflection dichroic mirror 30 and the green reflection dichroic mirror 31 that constitute a second color separating element. The green light passes through the field lens 36 and the incident side polarizing plate 39, and enters the liquid crystal panel 42. The blue light is reflected by the reflection mirror 12, thereafter passes through the field lens 37 and the incident side polarizing plate 40, and enters the liquid crystal panel 43. The red light is transmitted and refracted by the relay lenses 34 and 35, reflected by the reflection mirrors 32 and 33, then passes through the field lens 38 and the incident side polarizing plate 41, and enters the liquid crystal panel 44.

The three liquid crystal panels 42, 43, and 44 for forming left eye image are TN mode transmission-type liquid crystal panels using an active matrix system, and change the polarization state of the entering light in accordance with the control of the voltage applied to pixels according to a video signal. The incident side polarizing plates 39, 40, and 41 and the exit side polarizing plates 45, 46, and 47 are arranged on both sides of the liquid crystal panels 42, 43, and 44 respectively, such that the transmission axes are orthogonal to each other. The combinations of the liquid crystal panels 42, 43, and 44, the incident side polarizing plates 39, 40, and 41, and the exit side polarizing plates 45, 46, and 47 constitute the liquid crystal light valves for the left eye with respect to the respective color lights. The color lights are modulated by the respective liquid crystal light valves for the left eye, thus forming green, blue, and red images for the left eye.

With the color combining prism 48 serving as a second color combining element, from among the respective color lights that have passed through the exit side polarizing plates 45, 46, and 47, the red light and blue light respectively are reflected by the red reflection dichroic mirror and the blue reflection dichroic mirror, and combined with the green light. The liquid crystal light valves for the left eye with respect to the respective color lights are constituted such that the reflecting surfaces of the color combining prism 48 transmit and reflect green light as p-polarized light, and red and blue light as s-polarized light. The combined light that has passed through the color combining prism 48 enters the second wavelength-selective polarization rotating element 51. The second wavelength-selective polarization rotating element 51 rotates the polarization direction of green light by 90 degrees, and does not rotate the polarization direction of blue and red light. Accordingly, the green, blue, and red light beams become s-polarized light, and enter the polarized light combining prism 52.

The polarized light combining prism 52 is composed of a polarizing beam splitter having a dielectric multilayer film formed thereon, and combines image light for the right eye and image light for the left eye from the wavelength-selective polarization rotating elements 50 and 51. The polarized light combining prism 52 is arranged such that the p-polarized image light for the right eye from the wavelength-selective polarization rotating element 50 is transmitted, and the s-polarized image light for the left eye from the wavelength-selective polarization rotating element 51 is reflected. Therefore, unnecessary polarized light components for which polarization rotation caused by the wavelength-selective polarization rotating elements 50 and 51 is insufficient are removed due to reflection or transmission. Light that exits from the polarized light combining prism 52 is magnified and projected on a screen (not shown) by the projection lens 53. The light is magnified and projected in the state where the image light for the right eye is p-polarized light, and the image light for the left eye is s-polarized light. Therefore, a stereoscopic image is viewed by using polarization glasses made of glass for the right eye that absorbs s-polarized light components, and glass for the left eye that absorbs p-polarized light components.

Although a prism having a dielectric multilayer film formed thereon is used as a polarized light combining element in the above configuration, it is also possible to use a prism or a plate composed of a wire grid-type polarizing element having a metal film such as an aluminum film formed thereon. Although a wire grid-type polarizing element is expensive, since the change in the spectral characteristics with respect to the incident angle is small, such a polarizing element enables combining polarized light with little cross talk, a high transmittance of p-polarized light, and a high reflection efficiency for s-polarized light.

Further, in the above configuration, although the half mirror 8 is used as a light separating element, a flat wire grid-type polarized light separating mirror may be used. A wire grid-type polarized light separating mirror reflects the s-polarized light component of natural light from the condensing lens 7, and transmits the p-polarized light component, thereby separating the amount of entering light in the ratio of substantially 1:1. Although a wire grid-type polarized light separating mirror is expensive, the change in the spectral characteristics with respect to the incident angle is small, and the polarization converting element 6 in the illumination optical system is unnecessary, thus eliminating optical loss in the polarization converting element 6. Accordingly, the light utilization efficiency of the projection-type display apparatus can be improved.

Further, a retardation plate that rotates the polarization direction of p-polarized light that has passed through the polarized light separating mirror surface to the s-polarized light direction may be arranged on a glass substrate for forming a wire grid-type polarized light separating mirror, on a different surface from the surface on which a wire grid is provided. Light that exits from the polarized light separating mirror is the s-polarized light component of light, and thus the first color separating element and the second color separating element can be constituted by arranging dichroic mirrors having the same characteristics. Accordingly, image formation illumination light for the right eye and for the left eye can be equalized, and the cost can be reduced.

With the above projection-type display apparatus, image light for the right eye and image light for the left eye is projected continuously without being switched by time division, and thus it is possible to perform stereoscopic display with very little cross talk, and no flicker. Further, light from one light source is equally separated in the ratio of 1:1, and the liquid crystal panels for the right eye and for the left eye are illuminated with the separated light. Thus, the brightness and chromaticity of projection images for the right eye and for the left eye do not greatly change with the passage of time. Further, natural light from the light source efficiently is converted into linear polarized light, and the liquid crystal panels are uniformly illuminated with the converted light, thereby forming images for the right eye and for the left eye. For this purpose, three liquid crystal panels are used for each, and thus bright, uniform, and high definition projection images can be obtained. Since this apparatus is composed of one projection-type display apparatus constituted using one projection lens, installation adjustment is unnecessary, and the apparatus can display stable projection images.

### Embodiment 2

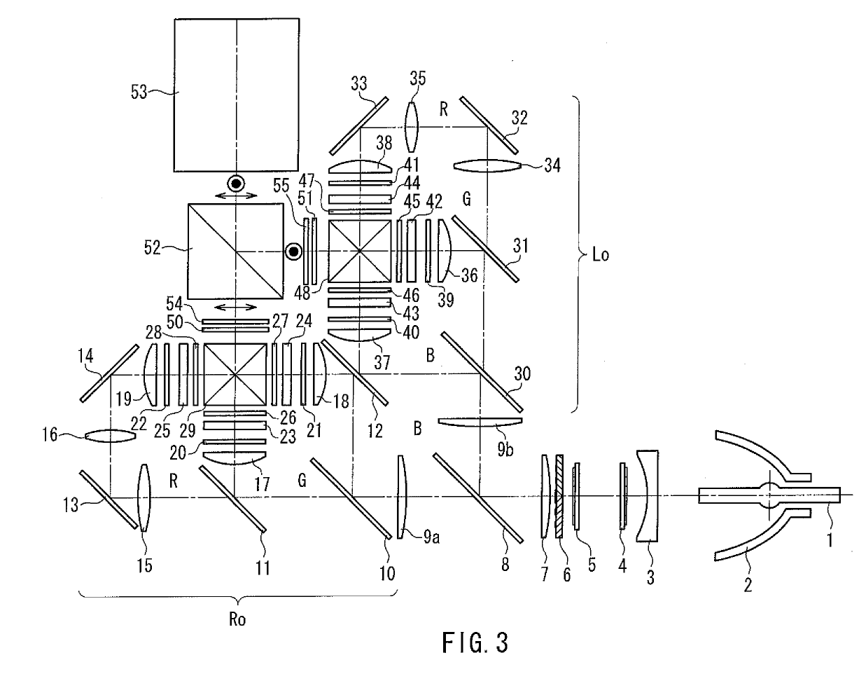

A projection-type display apparatus according to Embodiment 2 of the present invention is described with reference to FIG. 3. In this projection-type display apparatus, a TN mode or VA mode transmission-type liquid crystal panel is used for each liquid crystal light valve.

This projection-type display apparatus has basically the same configuration as that of the projection-type display apparatus according to Embodiment 1 shown in FIG. 1. Therefore, the same reference numerals are given to the same elements, and a redundant description is omitted. The present embodiment differs from Embodiment 1 in that first and second polarizing elements 54 and 55 respectively are arranged between the polarized light combining prism 52 and the wavelength-selective polarization rotating elements 50 and 51.

The first and second polarizing elements 54 and 55 are composed of polarizing plates made of a resin film that absorbs unnecessary polarized light components. The wavelength-selective polarization rotating elements 50 and 51 rotate the polarized light only in a desired wavelength band region. However, the rotation efficiency is not 100%, as is clear from the characteristics shown in FIG. 2. Therefore, about 10% of the transmitted light may be an unnecessary polarized light component. Although the unnecessary polarized light components also are cut out by the polarized light combining prism 52, the components are not always eliminated completely. In view of this, unnecessary polarized light components can be removed by arranging the first polarizing element 54 such that its absorption axis is in the s-polarized light direction. Similarly, the second polarizing element 55 is arranged such that its absorption axis is in the p-polarized light direction.

As described above, the projection-type display apparatus according to the present embodiment can perform stereoscopic display with even less cross talk, compared to the projection-type display apparatus according to Embodiment 1, by arranging the polarizing elements that absorb unnecessary polarized light components between the polarized light combining prism and the wavelength-selective polarization rotating elements.

Although it is described in the above embodiments that TN mode liquid crystal is used in the liquid crystal panels for image formation, VA mode liquid crystal also can be used. High-contrast projection images can be realized by using VA mode liquid crystal.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A projection-type display apparatus, comprising:
a light source;
an illumination optical system that condenses light from the light source and illuminates an illumination area with the condensed light;
a light separating element that separates white light from the illumination optical system in two directions;
first and second color separating elements that each separate the white light from the light separating element into blue, green, and red light beams;
three transmission-type liquid crystal light valves for the right eye that modulate the colors of light beams from the first color separating elements according to a video signal for the right eye;
three transmission-type liquid crystal light valves for the left eye that modulate the colors of light beams from the second color separating elements according to a video signal for the left eye;
a first color combining element that combines the blue, green, and red color lights that have been modulated by the three liquid crystal light valves for the right eye;
a second color combining element that combines the blue, green, and red color lights that have been modulated by the three liquid crystal light valves for the left eye;
a first wavelength-selective polarization rotating element that, from among the color lights combined by the first color combining element, rotates a polarization direction of a first predetermined color light so as to be aligned with a first polarization direction that is the same as a polarization direction of another color light;
a second wavelength-selective polarization rotating element that, from among the color lights combined by the second color combining element, rotates a polarization direction of a second predetermined color light so as to be aligned with a second polarization direction that is the same as a polarization direction of another color light, the second polarization direction being orthogonal to the first polarization direction;
a polarized light combining element that combines two polarized light beams that exit from the first and second wavelength-selective polarization rotating elements; and
a projection lens that magnifies and projects images respectively formed by the two polarized light beams combined by the polarized light combining element.

2. The projection-type display apparatus according to claim 1,
wherein first and second polarizing elements that each absorb an unnecessary polarized light component are provided between the polarized light combining element and the first and second wavelength-selective polarization rotating elements.

3. The projection-type display apparatus according to claim 1,
wherein the polarized light combining element is a polarizing beam splitter having a dielectric thin film formed thereon.

4. The projection-type display apparatus according to claim 1,
wherein the polarized light combining element is a wire grid-type polarizing prism.

5. The projection-type display apparatus according to claim 1,
wherein one of the first and second wavelength-selective polarization rotating elements is set so as to rotate polarization of the red and blue light beams from the color combining element by 90 degrees, and the other is set so as to rotate polarization of the green light beam from the color combining element by 90 degrees.

6. The projection-type display apparatus according to claim 1,
wherein the light separating element is a half mirror having a dielectric thin film formed thereon, which separates light into transmitted light and reflected light in a ratio of 1:1.

7. The projection-type display apparatus according to claim 1,
wherein the light separating element is a flat wire grid-type polarized light separating mirror.

8. The projection-type display apparatus according to claim 7,
wherein the wire grid-type polarized light separating mirror includes a retardation plate that rotates polarization of transmitted light.

9. The projection-type display apparatus according to claim 1,
wherein the liquid crystal light valve is composed of TN mode liquid crystal or VA mode liquid crystal panel.
